(19) United States
(12) Patent Application Publication
(10) Pub. No.: US 2005/0178777 A1
(43) Pub. Date: Aug. 18, 2005

(54) Insulating frozen dessert container jacket

(76) Inventor: Amanda Beth Wiedemann, Lakewood, WA (US)

Correspondence Address: LAW OFFICE OF POLLY L. OLIVER, P.O. BOX 4625, FEDERAL WAY, WA, 98063, US

(21) Appl. No.: 11/034,027

(22) Filed: Jan. 11, 2005

Related U.S. Application Data
(60) Provisional application No. 60/536,116, filed on Jan. 12, 2004.

(51) Int. Cl. B67D 5/00; B65D 25/00

(52) U.S. Cl. 220/739

(57) ABSTRACT

An insulating frozen dessert container jacket which will provide comfort and convenience by allowing a user to handle a cold or hot dessert container while keeping hands comfortably temperate. The container jacket also provides a comfortable and convenient means to grip a slippery container while protecting the user's hands and clothing from container sweat and/or leaks. The container jacket generally comprises a body element, typically in the form of a hollow cylinder or a truncated cone, and a base element permanently mounted on one end of the body (the narrow end if the body is a cone). The container jacket also comprises an air pressure outlet designed to equalize the air pressure between the interior and exterior of the jacket thereby facilitating insertion and removal of the dessert container.

### RELATED APPLICATION

This application claims priority under 35 U.S.C. 119(e) to U.S. Provisional Application Ser. No. 60/536,116, filed on Jan. 12, 2004.

### FIELD OF THE INVENTION

This invention pertains generally to container jackets and more particularly to an insulating frozen dessert container jacket.

### BACKGROUND OF THE FIELD

On the market today, frozen desserts, such as ice cream, are provided in containers of various shapes to be stored in the freezer. However, when the container is removed from the freezer for serving the dessert, the container may warm quickly, melting the frozen dessert therein. Some devices have been patented to insulate these types of containers once they are removed from the freezer.

### SUMMARY

The present invention solves the above-mentioned problems by providing a container jacket that insulates a frozen dessert container while offering ease of use to the consumer. The jacket comprises a body element, typically in the form of a hollow cylinder or a truncated cone (but the cross-section can be of any suitable shape), and a base element (generally planar and disk-shaped with an air pressure outlet therein) permanently mounted on one end of the body.

The container jacket is also adaptable and useful for hot containers as well, such as coffee, soup, frozen-to-heat grocery store convenience foods and take-out food items. For instance, many personal-sized soup containers comprise a paper or polystyrene-type material, not providing enough thermal insulation to handle the product comfortably or safely.

### BRIEF DESCRIPTION OF THE DRAWINGS

FIG. 1 is a perspective view of one embodiment of the container jacket with frozen dessert container therein;

FIG. 2A is a detail view of the body element;

FIG. 2B is a bottom view of the container jacket showing the base element and attachment seam;

FIG. 3 is a detail view of the coated material used for the container jacket;

FIG. 4 is a perspective view of a second embodiment;

FIG. 5A is a perspective view of a first alternate adjustable embodiment; and

FIG. 5B is a perspective view of a second alternate adjustable embodiment.

### DETAILED DESCRIPTION

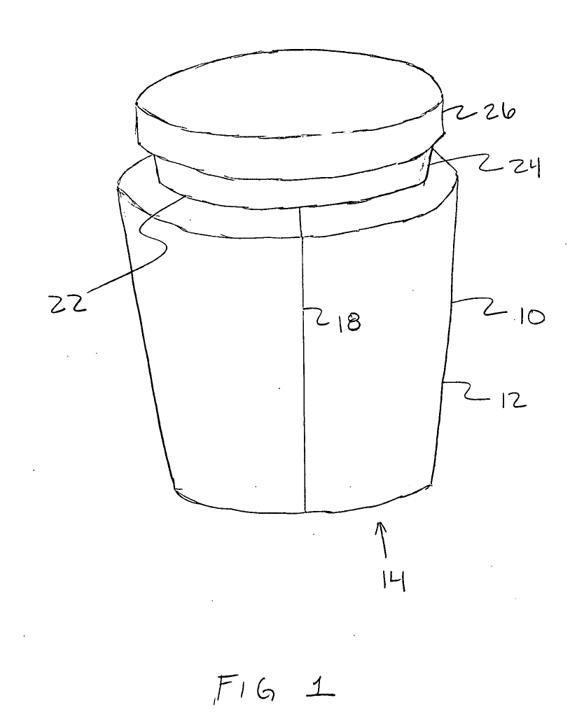

FIG. 1 shows how the container jacket 10 fits around and insulates a frozen dessert container 24. One end of the hollow body element 12 is closed with base element 14, but the opposing end is open and defines the insertion opening 22. The dessert container 24 is inserted into the insertion opening 22 at the wide end and pressed downward until it contacts the base 14 at the narrow end of the body 12. The jacket is sized such that the container lid 26 will be exposed. Thus the user can easily access the contents of the container. The jacket 10 is sized such that the container lid 26 will be exposed. Thus the user can easily access the contents of the container 24.

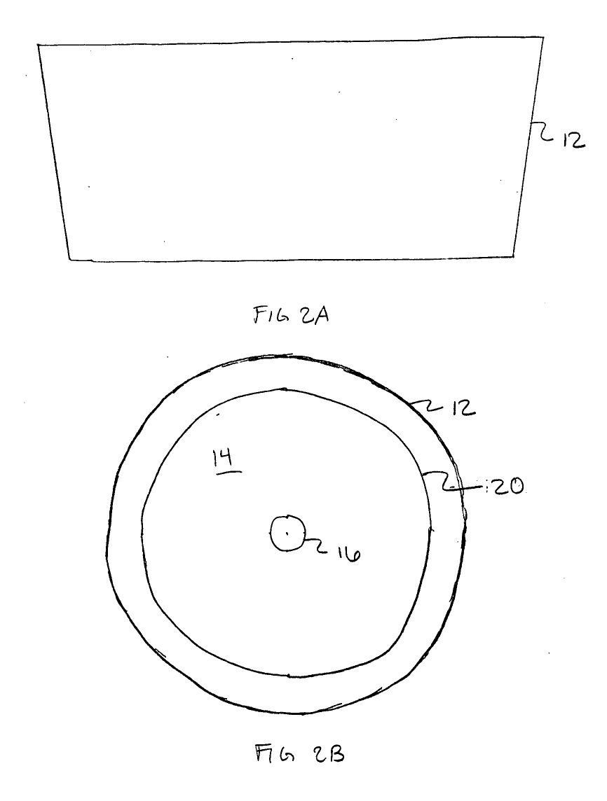

FIG. 2A shows a single sheet of material which is rolled into a truncated cone to form the body 12. Once rolled, the body seam 18 (shown in FIG. 1), defined by joining the opposing edges of the rolled sheet of material, holds the material in said shape defining the wide and narrow ends, the narrow end having an inner diameter for attachment of the base element. (Alternatively, the body element 12 or the entire container jacket 10 could be injection molded or otherwise manufactured as a one-piece unit.) The body seam 18 can be constructed in various ways to join the opposing ends of the material, including with adhesives or by fusing or sewing.

FIG. 2B shows how the generally planar base 14 comprises a single sheet of the same material in the shape of a disk, such disk having an outer diameter and defining a center air pressure outlet 16. Typically, the outer diameter of the base disk 14 is slightly larger than the inner diameter of the body cone 12 at the narrow end thereby providing for an interference fit. The body element 12 is thus placed over the base element 14 to assemble the container jacket 10. The attachment seam 20 at the juncture of the base 14 and the body 12 holds the base 14 to the body 12, substantially sealing the narrow end thereof, and the air pressure outlet 16 facilitates insertion and removal of the dessert container into the jacket 10 (by providing a vehicle for equalization of the air pressure both interior and exterior to the jacket). The completed container jacket thus defines an interior and an exterior. The attachment seam can likewise be constructed in various ways, including with adhesives or by sewing.

The air pressure outlet 16 shown in the drawings is represented as a single hole located in the geometric center of the base 14. It is understood, however, that that the air pressure outlet is not limited to the current number, size, shape, or location. For instance, the hole could be eccentrically located, or there could be several small holes punched through the base so as to make a pattern, such as the brand name or company logo. Likewise, the air pressure outlet could take the shape of a square, triangle, star, or other geometric shape.

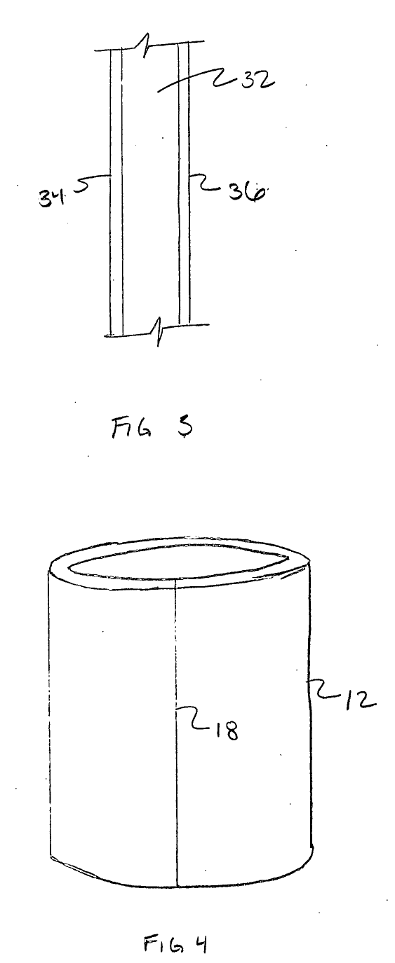

FIG. 3 shows how the insulating material 32 which makes up the insulating jacket 10, such as neoprene, may be coated on one or both sides. The coatings 34 and 36 provide smooth, finished surfaces that the container and user will come into contact with. (One common product that performs this function is nylon.) The body element 12 will thus be coated on both interior and exterior sides. However, the base element 14 will typically be coated on only the interior side, the side contacting the container, leaving the exterior side necessarily relatively rough in order to provide frictional qualities in relation to the tabletop or other surface on which it rests. In addition, it is understood that the first, interior coating 34 and the second, exterior coating 36 need not be the same but can be different coating materials.

FIG. 4 shows an alternate embodiment of the container jacket in which the body element is shaped into a right cylinder instead of a truncated cone. The body can be provided in many other shapes, such as a square or rectangle. In every case, the base element must be shaped so as to fit within and substantially seal one open end of the hollow body element leaving the other open end as the insertion opening for the frozen dessert container. For instance, a rectangle may be suitable for larger ice cream containers, and right cylinder may be suitable for coffee or soup. Such a three-dimensional insulating cavity defines an interior and an exterior as well as an air pressure outlet through the cavity wall in the base.

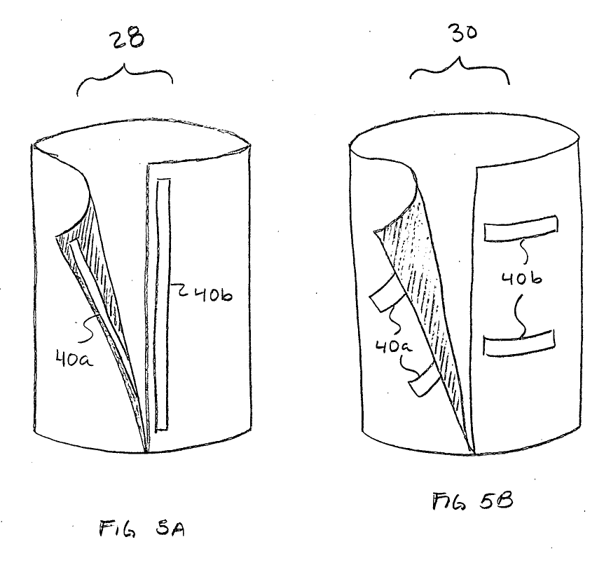

FIGS. 5A and 5B show variations of seam closures in which hook-and-loop fasteners (instead of adhesive) are used in order to make the closures adjustable. In these embodiments, the body is made of a single rectangular sheet of coated insulating material which is flexed and rolled into the cylinder shape; however, there is no seam—the closure is not fastened by adhesive. In FIG. 5A, the mating hook portion 40a and loop portion 40b run vertically along the body closure creating an adjustable vertical closure 28. In FIG. 5B, a wrap-type of jacket is shown with hook-and-loop fasteners (hook portion 40a and loop portion 40b) affixed generally horizontally (i.e., orthogonal to the closure edge) along the outside of the body to form an adjustable horizontal closure 30. The advantage to these alternate designs is the elimination of the need for the air pressure outlet. It is understood in FIGS. 5A and 5B that the body is shown with minimal wall thickness for illustration purposes only.

1. An insulating container jacket, comprising:
A body element of a hollow truncated cone having a wide end and a narrow end, said narrow end having an inner diameter, said body defining an interior and exterior and being constructed of an insulating material having a first coating on the interior side and a second coating on the exterior side;
A generally disk-shaped base element having an outer diameter and mounted to the body element so as to substantially seal the narrow end thereof and define an interior side and an exterior side, said base element being constructed of an insulating material have a coating on the interior side; and
An air pressure outlet located on the base element.

2. The container jacket of claim 1, wherein the body element comprises a single sheet of insulating material rolled into said truncated cone shape creating a seam at the juncture of the opposing ends and fastened thereat by adhesive.

3. The container jacket of claim 1, wherein the body element comprises a single sheet of insulating material rolled into said truncated cone shape creating a seam at the juncture of the opposing ends and fastened thereat by sewing.

4. The container jacket of claim 1 wherein the insulating material of said body and said base is neoprene and the first and second coatings of said body element are of nylon.

5. The container jacket of claim 4 wherein the interior coating of said base element is of nylon.

6. The container jacket of claim 1 wherein the outer diameter of the base element is slightly greater than the inner diameter of the narrow end of the body cone creating an Interference fit thereat, and the seal between the base element and the body element is effected by adhesive.

7. The container jacket of claim 1 wherein the air pressure outlet comprises a single hole located in the geometric center of the base disk.

8. An insulating container jacket, comprising:
A hollow body element having a first open end and a second open end, an interior and an exterior, said body element being constructed of a single sheet of coated insulating material being flexed and joined at the opposing ends by adhesive so as to define the hollow shape;
A generally planar base element being constructed of a single sheet of coated insulating material and being permanently frictionally mounted to the second open end of said body element so as to substantially seal the said second end, said seal being reinforced with adhesive; and an air pressure outlet comprising at least one hole located in the base element.

9. The container jacket of claim 8 wherein the body element is a right cylinder constructed of a rectangular sheet of material, and the base element is generally disk-shaped.

10. The container jacket of claim 8 wherein the hollow body element has a rectangular cross-section.

11. The container jacket of claim 8 wherein the insulating material is neoprene.

12. An insulated container jacket comprising:
A three-dimensional insulated cavity, the cavity wall being constructed of an insulating material and having interior and exterior sides, defining a single insertion opening providing access to the cavity, the cavity wall also defining an air pressure outlet opposite the insertion opening.

13. The container jacket of claim 10 wherein the insulating material is neoprene and the neoprene is coated on the interior side with nylon.

14. The container jacket of claim 11 wherein the air pressure outlet comprises a single hole through the cavity wall.

15. An insulated container jacket comprising:
A single rectangular sheet of coated insulating material flexed and rolled into a cylinder having an open insertion end and a closed end sealed with a generally planar base element, the opposing ends of the rectangle coming together to form the cylinder closure being oriented generally orthogonal to the base element,
Said closure being fastened by hook-and-loop fasteners, the hook portion being permanently mounted to one end of the rectangle and the loop portion being permanently mounted on the opposing end of the rectangle such that the portions will mate upon assembly.

16. The container jacket of claim 13 wherein the hook-and-loop fasteners are mounted vertically along the opposing ends of the rectangle and are oriented generally orthogonal to the base element.

17. The container jacket of claim 13 wherein the hook-and-loop fasteners are mounted horizontally on the opposing ends of the rectangle and are oriented generally parallel to the base element.
